(19) United States
(12) Patent Application Publication
(10) Pub. No.: US 2025/0220382 A1
(43) Pub. Date: Jul. 3, 2025

(54) SYSTEMS AND METHODS FOR PRODUCING BINAURAL AUDIO WITH HEAD SIZE ADAPTATION

(71) Applicant: Bose Corporation, Framingham, MA (US)

(72) Inventor: Charles Oswald, Salem, NY (US)

(73) Assignee: Bose Corporation, Framingham, MA (US)

(21) Appl. No.: 18/397,584

(22) Filed: Dec. 27, 2023

(51) Int. Cl. H04S 7/00; H04R 5/02

(52) U.S. Cl. CPC H04S 7/303; H04R 5/02; H04R 2499/13

(57) ABSTRACT

A vehicle audio system including a plurality of near-field speakers disposed to direct acoustic energy to a seating position within a vehicle cabin; a sensor disposed in the vehicle cabin providing a sensor signal representative of at least one of an ear position or a head size of a user seated in the seating position; a controller configured to drive the plurality of near-field speakers to produce a content signal at the seating position, wherein the controller is configured to provide a drive signal to drive the plurality of near-field speakers such that a binaural effect is created for the user, wherein the drive signal is based, at least in part, on the ear position or the head size of the user in the seating position.

### BACKGROUND

This disclosure relates to systems and methods for producing binaural audio with head size adaptation within a vehicle.

### SUMMARY

All examples and features mentioned below can be combined in any technically possible way.

According to an aspect, a vehicle audio system, includes: a plurality of near-field speakers disposed to direct acoustic energy to a seating position within a vehicle cabin; a sensor disposed in the vehicle cabin providing a sensor signal representative of at least one of an ear position or a head size of a user seated in the seating position; a controller configured to drive the plurality of near-field speakers to produce a content signal at the seating position, wherein the controller is configured to provide a drive signal to drive the plurality of near-field speakers such that a binaural effect is created for the user, wherein the drive signal is based, at least in part, on the ear position or the head size of the user in the seating position.

In an example, the drive signal drives the plurality of near-field speakers in an array configuration according to an interaural crosstalk cancellation filter to create the binaural effect.

In an example, the sensor signal is representative of the head size of the user, wherein the interaural crosstalk cancellation filter is selected from a plurality of stored interaural crosstalk cancellation filters according to head size and head position.

In an example, the sensor signal is representative of the head size of the user, wherein the interaural crosstalk cancellation filter is morphed according to the head size.

In an example, the drive signal drives the plurality of near-field speakers according to a virtualization filter such that a spatialized acoustic signal is provided to the user, the spatialized acoustic signal being perceived by the user as originating from at least one location distinct from the plurality of near-field speakers.

In an example, the sensor signal is representative of the head size of the user, wherein the virtualization filter is selected from a plurality of stored interaural crosstalk cancellation filters according to head size and head position.

In an example, the sensor signal is representative of the head size of the user, wherein the virtualization filter is updated according to the head size.

In an example, the sensor signal is representative of the head size of the user, wherein the interaural crosstalk cancellation filter is selected from a plurality of stored interaural crosstalk cancellation filters according to head size and head position.

In an example, the sensor is at least one camera directed to the user.

According to another aspect, at least one non-transitory storage medium storing program that, when executed by at least one processor, outputs drive signals for producing binaural audio with head size adaptation, includes: receiving a content signal for playback at a seating position within a vehicle cabin; receiving a sensor signal representative of at least one of an ear position or a head size of a user seated in the seating position; and providing a drive signal, comprising the content signal, to drive a plurality of near-field speakers disposed to direct acoustic energy to a seating position within the vehicle cabin such that a binaural effect is created for the user, wherein the drive signal is based, at least in part, on the ear position or the head size of the user in the seating position.

In an example, the drive signal drives the plurality of near-field speakers in an array configuration according to an interaural crosstalk cancellation filter to create the binaural effect.

In an example, the sensor signal is representative of the head size of the user, wherein the interaural crosstalk cancellation filter is selected from a plurality of stored interaural crosstalk cancellation filters according to head size and head position.

In an example, the sensor signal is representative of the head size of the user, wherein the interaural crosstalk cancellation filter is morphed according to the head size.

In an example, the drive signal drives the plurality of near-field speakers according to a virtualization filter such that a spatialized acoustic signal is provided to the user, the spatialized acoustic signal being perceived by the user as originating from at least one location distinct from the plurality of near-field speakers.

In an example, the sensor signal is representative of the head size of the user, wherein the virtualization filter is selected from a plurality of stored interaural crosstalk cancellation filters according to head size and head position.

In an example, the sensor signal is representative of the head size of the user, wherein the virtualization filter is updated according to the head size.

In an example, the sensor signal is representative of the head size of the user, wherein the interaural crosstalk cancellation filter is selected from a plurality of stored interaural crosstalk cancellation filters according to head size and head position.

In an example, the sensor is at least one camera directed to the user.

The details of one or more implementations are set forth in the accompanying drawings and the description below. Other features, objects, and advantages will be apparent from the description and the drawings, and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various aspects.

FIG. 1 an example schematic view representative of the audio system providing binaural audio with head size adaptation.

FIGS. 2A-2B depict a block diagram of a signal processing chain for providing binaural audio with head size adaptation, according to an example.

FIG. 3 depicts a block diagram of a signal processing module for providing binaural audio with head size adaptation, according to an example.

FIG. 4A, depicts a flowchart of a method for providing binaural audio with head size adaptation, according to an example.

FIG. 4B-4G depict a step of a flowchart of a method for providing binaural audio with head size adaptation, according to an example.

### DETAILED DESCRIPTION

The audio provided to a user within a vehicle can be improved by through various measures such as interaural crosstalk cancellation and virtualized audio. Interaural crosstalk cancellation employs one or more filters to cancel “interaural crosstalk,” that is, sound from a left or right channel leaking to the opposite ear, which reduces the sense of stereo separation between the left and right ears. Canceling interaural crosstalk is one way to create the effect of wearing headphones—i.e., the left and right ears receive separate acoustic signals—from speakers disposed away from the user's ears (such as within a headrest or headliner of the vehicle).

Virtualized audio (also referred to as spatialized audio) adjusts characteristics of the left and right channels—such as delay, phase, magnitude, and frequency—such that the user perceives the audio as originating at location distinct from the actual location of the speakers. Stated differently, virtualized audio leverages the various auditory cues that the human brain relies upon to determine the location of the source of the sound. By mimicking these cues, the audio can be made to sound as though it originates from a location other than the actual location of the speakers. This can be used, for example, to recreate the perception of sound as it would occur in the natural world, adding dimension and directionality to the audio. For example, an audio signal that originates behind the user, such as within a headrest, can be made to sound like it comes from a large soundstage in front of the user.

Both of these measures, interaural crosstalk cancellation and virtualized audio, rely on the orientation, and sometimes location, of the user's head in space to render the audio in a manner that recreates the desired effect. Thus, a sensor—such as one or more cameras, time-of-flight sensor, etc.—is used to track the user's head and provide information on the orientation and/or location of the user's head to a controller that renders the audio with interaural crosstalk cancellation or virtualized audio accordingly.

Typically, such algorithms for rendering audio with interaural crosstalk cancellation or virtualized audio rely on look direction (i.e., the direction that the user's head is facing) to update the interaural cross cancellation or virtualized audio filter. The look direction serves as a proxy for the location of the user's ears, so that acoustic energy can be tailored to each ear for the desired effect. This approach, however, fails to account for the head sizes of different users. As the user's head size varies, so does the distance between the user's ears, an important variable in the rendering of both interaural crosstalk cancellation and virtualized audio. More specifically, the user's head size, among other things, has a bearing on time difference of arrival between the user's ears, with the larger head sizes resulting in greater time differences of arrival. Larger head sizes can also increase shadowing of acoustic energy, and thus result in larger differences in magnitude of the acoustic energy at the user's ears, i.e., the interaural level difference. To accurately render audio with interaural crosstalk cancellation (or otherwise bring about a binaural effect) or virtualized audio, it is desirable to account for differences in user head size.

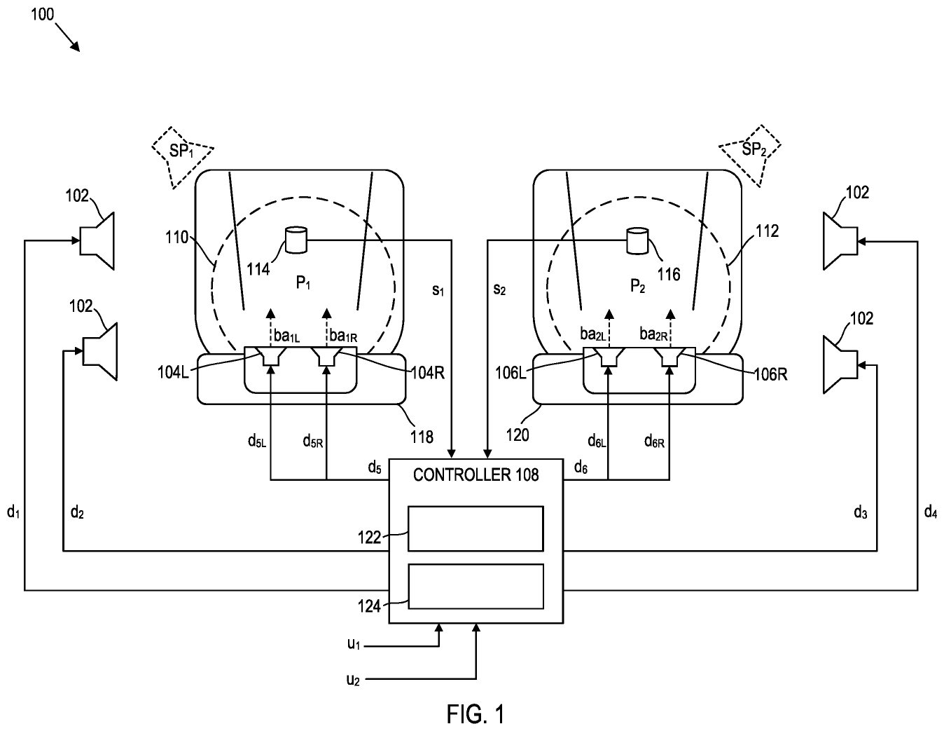

Accordingly, this disclosure describes, among other things, a vehicle audio system that employs speakers driven by a controller to create a binaural effect for a user at a seating position, the drive signal from the controller being configured according to a sensor signal representative of the size of the user's head or ear position. Turning now to FIG. 1, there is shown an example schematic view representative of the audio system providing binaural audio while accounting for the head size of a user. As shown, in this example, the vehicle cabin 100 includes a set of perimeter speakers 102 and near-field speakers 104, 106. In this example, perimeter speakers 102 and near-field speakers 104, 106 are driven by controller 108, providing drive signals d₁-d₆. Near-field speakers 104, 106 are driven by controller 108 to each provide acoustic energy to a user in manner that creates a binaural effect by creating interaural isolation between the acoustic energy at the user's left ear and the acoustic energy of the user's right ear. The drive signals d₅-d₆ are thus configured according to an inputs s₁, s₂ from sensors 114, 116 disposed in the vehicle cabin to detect the size of the user's head, or, alternatively, to detect the actual locations of the user's ears. The drive signals, in this manner, are tailored to the location of the user's ears, rather than only the user's look direction, and thus more accurately provide acoustic energy to the user's left and right ears to create the desired binaural effect (which can be used to produce stereo audio, spatialized audio, etc.).

More particularly, in the example of FIG. 1, drive signal d₅ is provided to the nearfield speakers 104, which include nearfield speakers 104L and 104R. Left nearfield speaker 104L and right nearfield speaker 104R together generate a binaural acoustic signal, represented by left acoustic signal ba_{1L} at the user's left ear and right acoustic signal ba_{1R} at the user's right ear. For the purposes of this disclosure “acoustic signal” and “acoustic energy” are used interchangeably. By maintaining interaural isolation of the left acoustic signal and the right acoustic signal (i.e., the left acoustic is received primarily at the user's left ear and the right acoustic signal is received primarily at the user's right ear) a binaural effect can be created for the user. It should also be understood that drive signal d₅ as a signal contains multiple channels, e.g., d_{5L} and d_{5R}, each channel typically being directed to and received at a respective speaker.

Further, it should be understood that, although two speakers are shown, any number of speakers can be disposed to create the binaural effect for the user. For example, multiple speakers can be disposed on the left side of the user and together create left acoustic signal ba_{1L}. Similarly, multiple speakers can be disposed on the right side of the user and together create right acoustic signal ba_{1R}. Additionally, in certain examples, the plurality of nearfield speakers, including at least speakers 104L and 104R, can be driven in an array configuration by controller 108—e.g., through an interaural crosstalk canceller, as described in more detail below—to direct the left acoustic signal ba_{1L} to the user's left ear and the right acoustic signal ba_{1R} to the user's right ear, while directing nulls to the other ears to create the interaural isolation of the left acoustic signal ba_{1L} and the right acoustic signal ba_{1L}. Further, other types of speakers, besides only nearfield speakers, can be used to deliver the binaural acoustic signal to the user. For example, ultrasonic speakers can be leveraged to direct acoustic energy to the user's left and right ears.

For the purposes of this disclosure a binaural effect recreates the effect of wearing headphones, in which a separate acoustic signal is provided to each ear. In one example, the binaural effect can deliver to the user a stereo signal, in which the left ear receives the left channel and the right ear receives the right channel. In general, a binaural acoustic effect does not demand complete isolation of the left acoustic energy and right acoustic energy. Indeed, it is expected that some degree of the left acoustic energy can be leaked to the user's right ear and some degree of right acoustic energy can be leaked to the user's left ear.

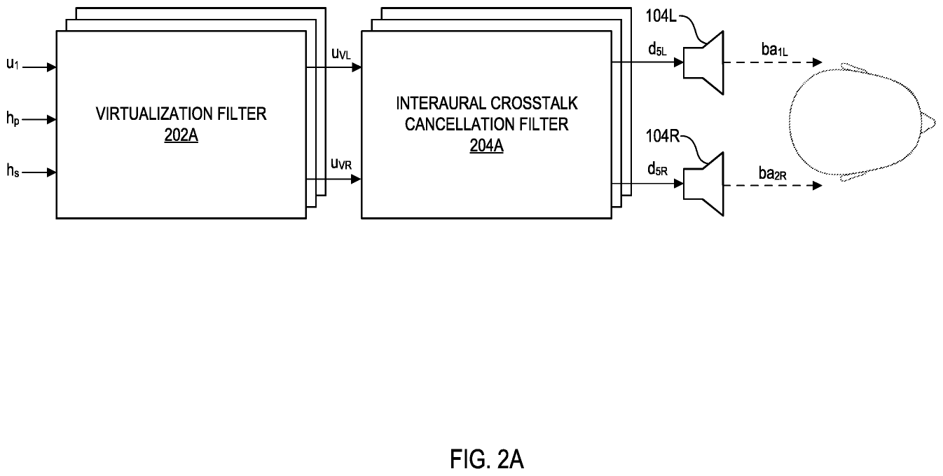

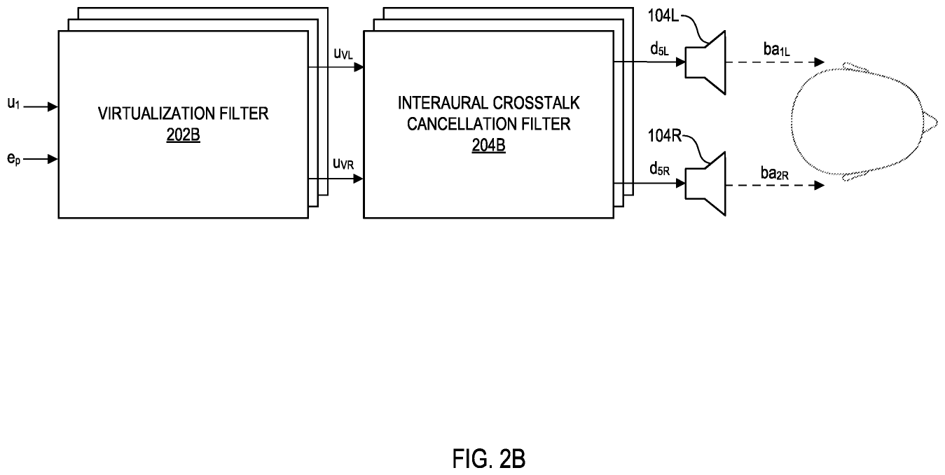

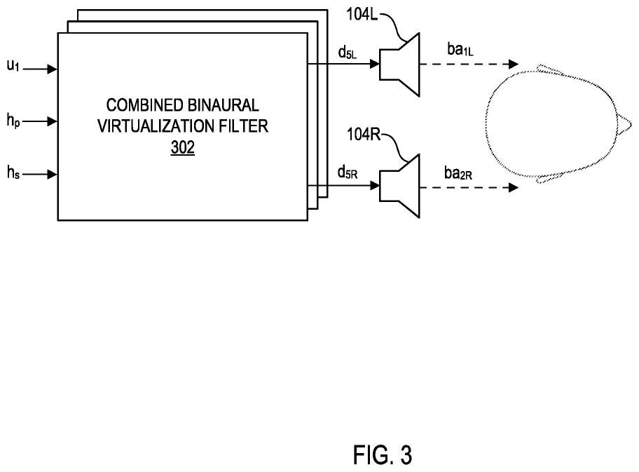

Additionally, in certain examples, the binaural effect can be virtualized by controller 108 adjusting the relative phase and delay of the left acoustic energy and right acoustic energy. As a result, the user perceives the audio as originating from a source distinct from the actual source of the acoustic signal, e.g., nearfield speakers 104, 106. The virtualized source in FIG. 1 is represented as virtualized speakers SP₁ and SP₂. In this example, the user seated in seating position P₁ perceives the audio as originating from virtualized speaker SP₁ while the user seated position P₂ perceives the audio as originating from virtualized speaker SP₂. It should be understood that, while a single virtualized speaker is represented for each user, any number of virtualized speakers located at in any number of positions can be produced for each user. A more detailed discussion of creating the virtualized audio is provided below in conjunction with FIGS. 2 and 3.

In certain examples, nearfield speakers 104, 106 can be disposed within the seats 118, 120, respectively directing a binaural acoustic signals ba₁, ba₂ to listening zones 106, 108. For example, as shown, nearfield speakers 104, 106 can be disposed within the headrest of seats 118, 120; however, in alternative examples, nearfield speakers 104, 106 can be disposed elsewhere in the seat suitable for delivering the midrange acoustic signal to the respective listening zone. For example, nearfield speakers 104, 106 can alternatively be disposed in the seatback (e.g., in line with or above the user's shoulders), headliner, or any other place that is disposed near to the user's ears and suitable for delivering binaural acoustic signals to the user while maintaining at least 3 dB of inter-seat isolation (e.g., a signal produced at seating position P₁ by nearfield speakers 104L, 106R is at least 3 dB quieter at the seating position P₁).

As used herein, controller 108 comprises a processor 122 (e.g., a digital signal processor) and a non-transitory storage medium 124 storing program code, together with any associated circuitry. The program code, when executed by processor 122, carries out the various functions and methods described in this disclosure. Processor 122 can thus be programmed, according to program code stored in storage medium 124, to provide a drive signal to create a binaural effect for a user, taking into account the size of the user's head or the location of the user's ears, among other functions describe in this disclosure. Controller 108 can further comprise more than one processor and/or more than one memory to perform such functions.

For the purposes of this disclosure, references to the controller driving the speakers or preparing a drive signal for the speakers should not be understood to necessarily exclude intermediate circuitry or processing existing between controller 108 and speakers within the cabin (e.g., perimeter speakers 102 and nearfield speakers 104, 106). For example, the drive signals d₅ and d₆ output from controller 108 can be amplified by one or more amplifiers disposed between controller 108 and nearfield speakers 104, 106 such that the drive signals are of an appropriate magnitude.

Sensors 114, 116 can be comprised any sensor suitable for detecting the size of a user's head or the location of the user's ears. For example, sensors can comprise one or more two-dimensional cameras, LiDAR sensors, infrared sensors, structured light scanners, or some combination of these sensors. Algorithms for detecting the size of objects using such sensors, and other sensors, is understood and so will not be further described here; however, it should be understood that controller 108 can be programmed to automatically execute an algorithm for detecting the size of the user's head according to the output of sensors 114, 116.

Sensors 114, 116, can, in one example, be the same as the sensors for detecting the position of the user's head or can be different than the sensors for detecting the position of the user's head. Further, in certain examples, there can be some overlap between the sensors used to detect the user's head size and those used to detect the position of the user's head. (As used herein, the position of the user's head refers to both its orientation and location in space.)

Turning now to FIG. 2 there is shown a block diagram representing programmatic modules for performing virtualization and interaural crosstalk cancellation. Generally, algorithms for each are known and so a detailed description of each will be omitted; however, descriptions of the improvements to these algorithms, incorporating the head-size or ear position of the user will be described in detail.

In an example, virtualization filter 202—representing an algorithm for producing virtualized audio—can receive as inputs content signal u₁ and head position hₚ. (In certain examples, virtualization can receive only the orientation of the user's head, as location is not necessarily required). Virtualization filter outputs binaural output signal comprising u_{VL} and u_{VR}, which together create the impression to the user that the acoustic signal is originating from at least one location remote from speakers 104. In other words, as described above, the user perceives the acoustic signal as originating, not from speakers 102, but from a virtual source located at a point in space determined according to the parameters of virtualization filter 202. At a general level, virtualization algorithms—such as implemented by virtualization filter 202—implement a transfer function that adjusts the relative characteristics of the binaural output signal u_{VL}, u_{VR}, including interaural time difference (i.e., the time difference between the production of acoustic signals u_{VL} and u_{VR}) and interaural level difference (i.e., the difference in magnitude of acoustic signals u_{VL} and u_{VR}), to create the impression that the acoustic signal originates from the virtual source.

Such transfer functions are usually based on a head model used to identify the appropriate values of the relative characteristics of the binaural output signal for a given head position. More typically, however, virtualization algorithms for producing spatialized audio are based on a head-related transfer function. A head-related transfer function is a set of frequency-domain filters that represent the acoustic transformations that occur for an acoustic signal transmitted from different audio source positions to the user's left and right ears. Thus, the filters of the head-related transfer function transform the content signal u₁ into a virtualized binaural output signal comprising u_{VL}, the content signal as perceived at the left ear, and u_{VR}, the content signal as perceived at the right ear, for a set of positions about the user's head. In general, virtualization algorithms implementing transfer functions (e.g., head-related transfer functions) for accomplishing virtualized audio for a given head position are known, and any such suitable virtualization algorithm can be used. In addition, virtualization algorithms can simulate other auditory features of acoustic signals, such as first and second order reflections, to enhance the perception of the acoustic signal.

In general, a virtualization filter implementing a transfer function, such as a head-related transfer function, can be stored for each head position (this is represented by the stacked virtualization modules 202 in FIG. 2). Thus, as the user's head position changes, (as represented by head position signal hₚ) the appropriate virtualization filter is retrieved from memory and implemented in real-time to provide the user with the appropriate binaural output signal for the current head position.

Interaural crosstalk cancellation filter 204 represents an algorithm for reducing or eliminating crosstalk, which occurs when audio intended for one ear is heard by the opposite ear. Interaural crosstalk cancellation filter 204 can be implemented as a set of filters (represented as the stacked interaural crosstalk cancellation filters 204), each filter functioning to array the output speakers (e.g., speakers 104L, 104R) according to beamforming techniques to cancel crosstalk for a respective head position. Thus, in this example, interaural crosstalk cancellation filter 204 receives virtualized binaural output signal u_{VL} and u_{VR} and, depending on the position of the user's head, implements the appropriate crosstalk cancellation filter to cancel (i.e., reduce or eliminate) crosstalk between the left and right acoustic signals at the use's ears. More specifically, interaural crosstalk cancellation filter outputs drive signals d_{5L} to nearfield speaker 104L and d_{5R} to nearfield speaker 104R, such that nearfield speakers 104L and 104R are arrayed to cancel crosstalk of the acoustic signals ba_{1L} and ba_{1R} at the user's ears. As the user's head position changes, the appropriate crosstalk cancellation filter is retrieved from memory and implemented in real-time. Additionally, as described above, nearfield speakers 104L and 104R are representative of any number of speakers on the left and right, and thus drive signals d_{5L} and d_{6L} are representative of any number of drive signals that can array the left and right speakers to bring about the crosstalk cancellation.

In addition to head position, the head size can be received at virtualization filter 202, encoded as signal hₛ. As mentioned above, head size can impact both the time difference of arrival and the interaural level difference, as well as other factors of the way that sound is perceived (e.g., due to head diffraction). Thus, for example, for a user with a relatively small head, the time difference of arrival will be less than for a user with a relatively large head. Though small, failing to account for these differences will result in degraded performance of the virtualization. To account for these differences, virtualization filter 202 can be adapted according to head-size. In one example, each stored transfer function implementing appropriate characteristics of the binaural output signal, such as the head-related transfer function, can be adapted by updating it according to the received head size. For example, various parameters of the transfer function, such as the time difference of arrival and the interaural level difference, can be adjusted according to the measured size of the user's head. In general, due to head diffraction, lateral arrivals have larger interaural time difference and interaural level difference values which could likewise be accounted for in the update. Thus, for example, each of these transfer functions can be updated as it is retrieved (or the entire set can be updated once the head size of the user is detected) as appropriate for the detected head size. Updating the transfer function can occur using, for example, a look up table containing the appropriate adjustments to the parameters of the transfer function for each of a set of head sizes.

Alternatively, rather than updating each transfer function, an additional set of transfer functions for each size can be stored. For example, if the user is detected as having a relatively small head, an appropriate set of transfer functions tailored to a relatively small head can be used and retrieved according to the user's head position. Likewise, if the user has a relatively large head, an appropriate set of transfer functions tailored to a relatively large head can be used and retrieved according to the user's head position. (This can be thought of as pre-updating the transfer functions and storing them, rather than updating them once the user's head size has been detected.)

Further, it can be necessary to round the detected value of the user's head to a nearest stored value. For example, if transfer functions are stored for small, medium, and large heads, controller 108 must additionally be programmed to retrieve the set of transfer functions nearest in size to the detected head size. Thus, if the user's head size is nearest to the set of “small” transfer functions, then the small transfer functions are retrieved according to the user's head position. Likewise, if the stored transfer functions are updated according to a set of adjustments that are stored in a look up table, it can be necessary to determine which head size of the look up table is nearest to the detected head size. Of course, it should be understood that any number of suitable head sizes can be stored, not just “small,” “medium,” and “large,” which are only given as examples.

Interaural crosstalk cancellation filter 204 can likewise be adjusted according to the detected head size. Each stored filter of interaural crosstalk cancellation filter 204 is typically created using in-situ measurements of the interaural crosstalk that occurs for each head position. The measured crosstalk is used to generate a filter solution that arrays the existing speakers in a manner that cancels the crosstalk at the user's ears. Thus, for each head position, the implemented crosstalk cancellation filter is created to cancel the crosstalk measured at the user's ears in that head position. This process, however, naturally assumes a distance between the user's ears. Interaural crosstalk cancellation filter 204 can thus be adapted by adding crosstalk cancellation filter solutions for measurements taken for larger and smaller distances (corresponding to larger and smaller heads). Thus, once the user's head size is detected, the correct set of stored interaural crosstalk cancellation filters—i.e., those featuring solutions to measurements taken at distances approximating the user's head size—can be implemented. (As described in connection with the virtualization filter 202, this can require a step of determining which of the stored sets the detected head size is nearest.) Alternatively, the solutions for one head size, such as an average head size, can be morphed as appropriate given the detected head sizes. For example, this could be accomplished with a mathematical model that is parameterized by head size or through simulations (these could be continuous or discrete).

It should be understood that the head position (i.e., comprising the location of the user's head and its orientation) is itself used as a proxy for the location of the user's ears. This can be improved, as described above, by detecting the size of the user's head. In alternative examples, however, rather than receiving an input of look direction as a proxy for ear location, the location of the user's ears in space can used directly. In this example, sensors 114, 116 can detect each location of the user's ears and provide this information to virtualization filter 202B and interaural crosstalk cancellation filter 204B. Thus, rather than storing a set of transfer functions dependent on position (or orientation), virtualization filter 202B includes a set of head-related transfer functions stored based on ear location. Ear location includes, at least inherently, the distance between the ears since the location of each ear is individually tracked. Likewise, interaural crosstalk cancellation filter 204B includes a set of crosstalk cancellation filters stored based on ear location.

In the ear-location example, there are naturally limits on the number of ear locations that would be stored. For example, measurements for ear locations that exceed the natural maximum possible distance (or even a normally large distance) between the ears need not be measured and stored. Further, it need not be necessary to measure each position for each possible distance between the ears. Rather, a certain number of ear distances can be measured and stored (e.g., small, medium, and large ear distances) and the closest value to the actual distance, based on the ear locations, can be retrieved and used.

It should be understood that in alternative examples, either of virtualization filter 202A, 202B, or interaural crosstalk cancellation filter 204A, 204B can be omitted. In which case, either the virtualization or the binaural effect can be provided without the other. For example, interaural crosstalk cancellation filter 204A can be implemented without virtualization filter 202A, using the arraying of the speakers to create the binaural effect for the user without virtualizing the audio.

Further, while the interaural crosstalk cancellation filter 204 is one example of producing a binaural effect for a user, other potential solutions exist. For example, a single filter solution could be implemented that would provide both the virtualized audio and the binaural effect. An example of this is shown in FIG. 3, in which combined binaural virtualization filter 302 provides both the virtualized audio and drives speakers in a manner that produces a binaural effect for the user (e.g., according to various beamforming techniques). At high level, virtualization filter 202 and interaural crosstalk cancellation filter 204 can be convolved into one block. Methodologies to solve these include independent solves and simultaneous/joint solves. An advantage of the simultaneous solve methodology is the capability of minimizing the overall error of the entire combined block.

It should be understood that, although the processing chain for speakers 104L and 104R have been shown in FIGS. 2-3, a similar or identical processing chain could be implemented to drive speakers 106L and 106R. Further, although the same content signal could be provided in both seating positions P₁ and P₂, in alternative examples, content signal u₁ can be provided in seating position P₁, while separate content signal u₂ could be provided in seating position P₂. Additionally, while only two seating positions are shown, any number of seating positions can be created within the vehicle cabin. The creation of separate listening zones is described in more detail U.S. Pat. No. 11,696,084 titled Systems and Methods for Providing Augmented Audio herein incorporated by reference in its entirety.

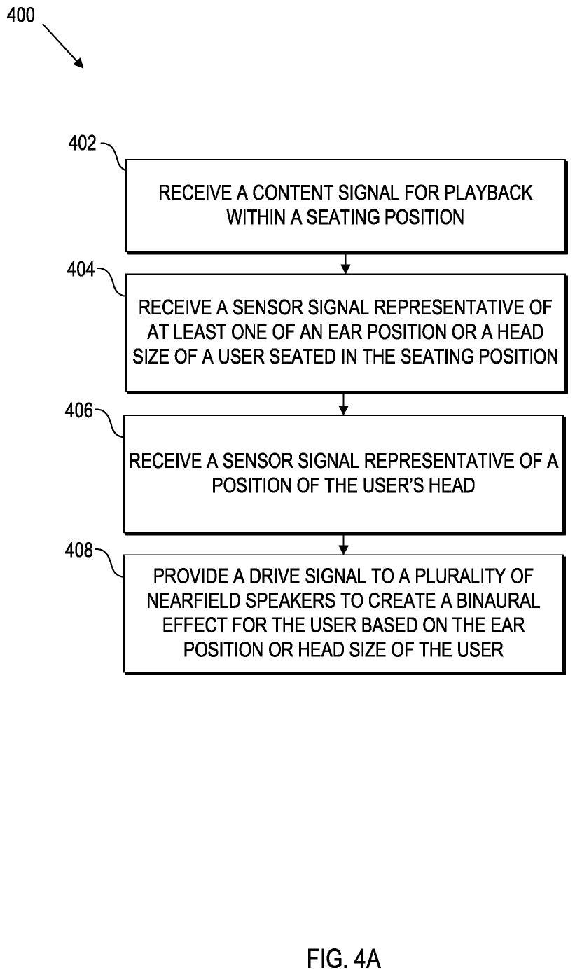

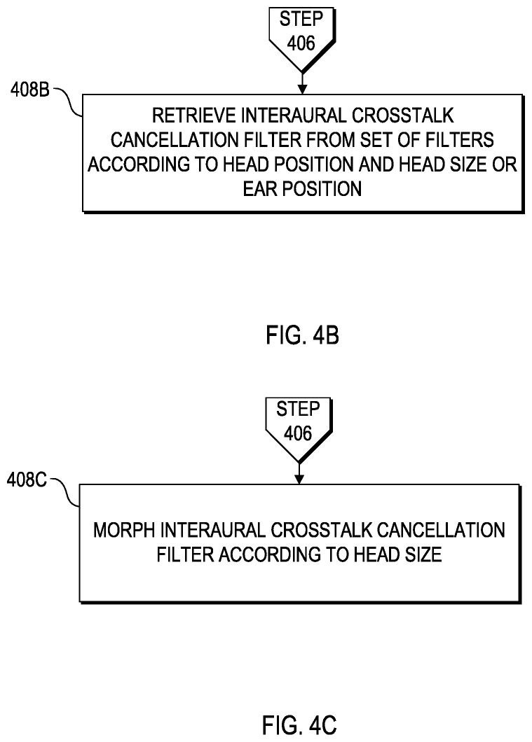

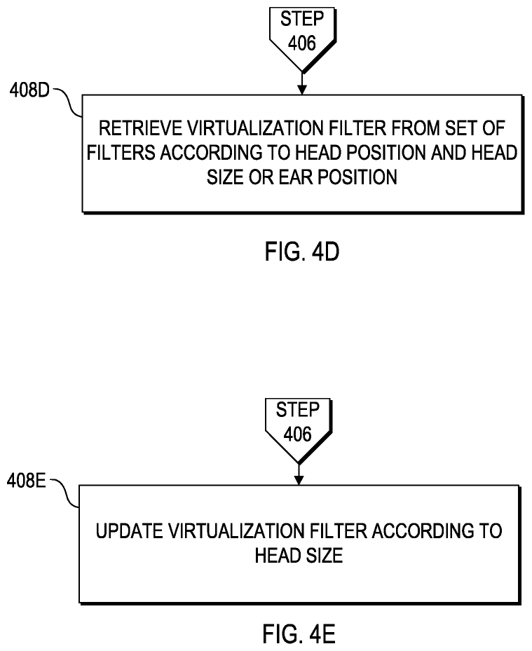

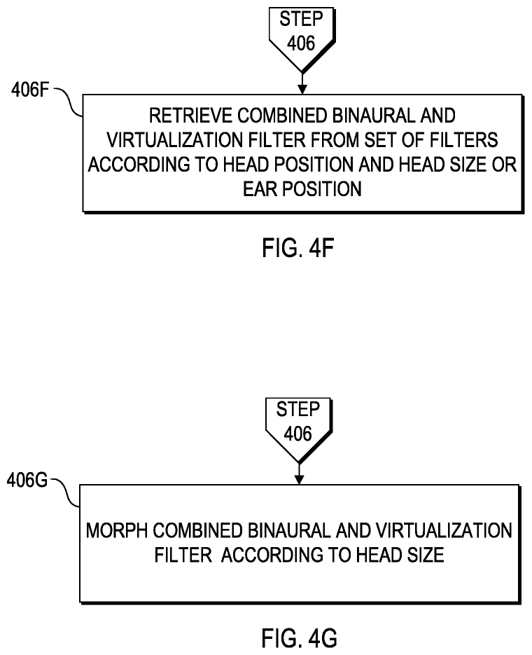

FIG. 4 depicts a flowchart of a method 400 for producing a binaural effect for a user factoring in the user's head size or ear location. The steps of method 400 can be carried out by a controller comprising one or more processors programmed according to program code stored on one or more non-transitory storage media, along with any associated circuitry (such as controller 108). Certain of steps 400 can be understood in conjunction with the descriptions of the vehicle audio system of FIG. 1 and signal processing chains of FIGS. 2-3 provided above.

At step 402, a content signal is received for playback within a seating position. The content signal can be, for example, music or spoken word content and can, in various examples, be received from a device such as a mobile device transmitting the content signal to the controller or can be received from a non-transitory storage media within the vehicle retrieving the content signal.

At step 404, a sensor signal representative of at least one of an ear position or a head size of a user seated in the seating position is received. The sensor signal can be received from a sensor such as one or more two-dimensional cameras, LiDAR sensors, infrared sensors, structured light scanners, or some combination of these sensors. The sensor signal can have encoded within it the head size of the user or the ear position, as determined from a processor associated with the sensor. Alternatively, the controller can be configured to determine from the sensor signal the head size or ear position of the user. Algorithms for determining the size of an object, or the location of an object, are generally known. Further, processing techniques such as machine learning algorithms could be utilized to measure the size of the user's head or detect the location of the user's ears. The process of measuring the size of the user's head can be performed automatically, rather than requiring the user to initiate a head-size measuring process, manually input a head size, or don an apparatus for measuring the head-size of the user. Thus, upon or before the start of playback, the user's head size can be measured and used to produce the audio with a binaural effect in step 408.

At step 406, a sensor signal representative of a position of the user's head is received. This sensor signal can be received from the same sensor used to detect the size of the user's head; however, it is conceivable that separate sensors could be used. Generally, this step is only necessary if the user's head size is used. If the user's ear location is used in place of look direction, this step and step 404 collapse into a single step of determining the location of the user's ears.

At step 408, a drive signal is provided to a plurality of nearfield speakers to create a binaural effect for the user based, at least in part, on the ear position or head size of the user. The drive signal can comprise multiple signals, respectively directed to nearfield speakers disposed about the seating position to deliver acoustic energy to the seating position. For example, the nearfield speakers can be located in the headrest, the seatback (e.g., in line with or above the user's shoulders), headliner, or any other place that is disposed near to the user's ears and suitable for delivering binaural acoustic signals to the user while maintaining at least 3 dB of inter-seat isolation. Additional types of speakers, such as ultrasonic speakers and the perimeter speakers could be used to augment the acoustic output of the nearfield speakers. The binaural effect can be created, for example, through an interaural crosstalk cancellation filter that arrays the nearfield speakers to create interaural isolation between the left and right acoustic signals. Additionally, the acoustic energy can be virtualized such that the user perceives the acoustic energy as originating from at least one location distinct from the location of the nearfield speakers. The virtualization can be accomplished by, for example, a virtualization filter.

In general, the binaural effect and/or the virtualization, the filter(s) are selected from a set of filters according to head size or an existing filter must be updated or morphed according to the head size.

For example, the interaural crosstalk cancellation filter can include a set of filters that are retrieved and implemented according to head position. This set of interaural crosstalk cancellation filters can be extended to adjust to different head sizes, in one example, by storing additional sets of interaural crosstalk cancellation filters for different head sizes. Thus, as shown in FIG. 4B, step 408 is executed, at least in part, by selecting a set of interaural cancellation filters according to the detected head size. Stated differently, as shown in FIG. 408B, the interaural crosstalk cancellation filter is retrieved from a set of stored interaural crosstalk cancellation filters according to both head size and head position. Alternatively, the filters can be retrieved according to ear position. Tracking the ears individually within space inherently detects the difference between the ears. Accordingly, in an alternative example, the set of cross talk cancellation filters can be stored for a set of unique ear locations and retrieved according to the respective position of the ears.

Alternatively, as shown in FIG. 408C, the stored interaural crosstalk cancellation filters can be morphed according to an algorithm to compensate for the different effects created by the change in head size, relative to the head size from which the stored crosstalk cancellation filters were generated.

Likewise, the virtualization filter can be extended to adjust to different head sizes by storing additional virtualization filters for different head sizes. Similar to the interaural crosstalk cancellation filter, a set of virtualization filters are stored according to head position. These virtualization filters, for example, can comprise transfer functions (e.g., head-related transfer functions) that account for the position and/or orientation of the user's head and/or ears relative to the virtualized source. This set can be extended to include virtualization filters for multiple head sizes, which may affect ear positions. Thus, as shown in step 406F, the virtualization filter can be retrieved from a set of virtualization filters according to both head position (or head orientation) and head size. Alternatively, the virtualization filter can be retrieved according to ear position.

In another example, as shown in step 408E, the stored virtualization filter can be updated according to an algorithm to compensate for the different effects created by the change in head size, such as time difference of arrival and interaural level difference, relative to the head size from which the stored virtualization filter was generated.

In another example, the binaural effect and the virtualization can be implemented with a combined filter. In such an example, a set of the combined filter can be stored and retrieved according to head position and head size, as shown in step 406F. Alternatively, the filter solution of such a filter could be morphed according to a function to account for different measured head sizes, as shown in step 406G.

It should be understood that steps 408B-408G represent at least partial implementations of step 408. Indeed, these steps describe various aspects of producing the binaural effect or the virtualization, not the complete steps required to produce a drive signal, which are generally known in the art. Indeed, steps 408D and 408E do not, on their own, produce a binaural effect for the user, and thus should be understood as an example of how a drive signal that produces the binaural effect can be further adjusted to provide binaural audio. In various examples, certain of steps 408B-408D can be combined in implementing step 408. For example, steps 408B and 408D can be combined to produce a binaural effect with virtualized audio. Such a processing chain is shown, for example, in FIGS. 2-3.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media or storage device, for execution by, or to control the operation of, one or more data processing apparatus, e.g., a programmable processor, a computer, multiple computers, and/or programmable logic components. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

What is claimed is:

1. A vehicle audio system, comprising:
a plurality of near-field speakers disposed to direct acoustic energy to a seating position within a vehicle cabin;
a sensor disposed in the vehicle cabin providing a sensor signal representative of at least one of an ear position or a head size of a user seated in the seating position;
a controller configured to drive the plurality of near-field speakers to produce a content signal at the seating position, and
wherein the controller is configured to provide a drive signal to drive the plurality of near-field speakers such that a binaural effect is created for the user, wherein the drive signal is based, at least in part, on the ear position or the head size of the user in the seating position.

2. The vehicle audio system of claim 1, wherein the drive signal drives the plurality of near-field speakers in an array configuration according to an interaural crosstalk cancellation filter to create the binaural effect.

3. The vehicle audio system of claim 2, wherein the sensor signal is representative of the head size of the user, wherein the interaural crosstalk cancellation filter is selected from a plurality of stored interaural crosstalk cancellation filters according to head size and head position.

4. The vehicle audio system of claim 2, wherein the sensor signal is representative of the head size of the user, wherein the interaural crosstalk cancellation filter is morphed according to the head size.

5. The vehicle audio system of claim 1, wherein the drive signal drives the plurality of near-field speakers according to a virtualization filter such that a spatialized acoustic signal is provided to the user, the spatialized acoustic signal being perceived by the user as originating from at least one location distinct from the plurality of near-field speakers.

6. The vehicle audio system of claim 5, wherein the sensor signal is representative of the head size of the user, wherein the virtualization filter is selected from a plurality of stored interaural crosstalk cancellation filters according to head size and head position.

7. The vehicle audio system of claim 5, wherein the sensor signal is representative of the head size of the user, wherein the virtualization filter is updated according to the head size.

8. The vehicle audio system of claim 5, wherein the sensor signal is representative of the head size of the user, wherein the interaural crosstalk cancellation filter is selected from a plurality of stored interaural crosstalk cancellation filters according to head size and head position.

9. The vehicle audio system of claim 1, wherein the sensor is at least one camera directed to the user.

10. At least one non-transitory storage medium storing program that, when executed by at least one processor, outputs drive signals for producing binaural audio with head size adaptation, comprising:
receiving a content signal for playback at a seating position within a vehicle cabin;
receiving a sensor signal representative of at least one of an ear position or a head size of a user seated in the seating position; and
providing a drive signal, comprising the content signal, to drive a plurality of near-field speakers disposed to direct acoustic energy to a seating position within the vehicle cabin such that a binaural effect is created for the user, wherein the drive signal is based, at least in part, on the ear position or the head size of the user in the seating position.

11. The at least one non-transitory storage medium of claim 10, wherein the drive signal drives the plurality of near-field speakers in an array configuration according to an interaural crosstalk cancellation filter to create the binaural effect.

12. The at least one non-transitory storage medium of claim 11, wherein the sensor signal is representative of the head size of the user, wherein the interaural crosstalk cancellation filter is selected from a plurality of stored interaural crosstalk cancellation filters according to head size and head position.

13. The at least one non-transitory storage medium of claim 11, wherein the sensor signal is representative of the head size of the user, wherein the interaural crosstalk cancellation filter is morphed according to the head size.

14. The at least one non-transitory storage medium of claim 10, wherein the drive signal drives the plurality of near-field speakers according to a virtualization filter such that a spatialized acoustic signal is provided to the user, the spatialized acoustic signal being perceived by the user as originating from at least one location distinct from the plurality of near-field speakers.

15. The at least one non-transitory storage medium of claim 14, wherein the sensor signal is representative of the head size of the user, wherein the virtualization filter is selected from a plurality of stored interaural crosstalk cancellation filters according to head size and head position.

16. The at least one non-transitory storage medium of claim 14, wherein the sensor signal is representative of the head size of the user, wherein the virtualization filter is updated according to the head size.

17. The at least one non-transitory storage medium of claim 14, wherein the sensor signal is representative of the head size of the user, wherein the interaural crosstalk cancellation filter is selected from a plurality of stored interaural crosstalk cancellation filters according to head size and head position.

18. The at least one non-transitory storage medium of claim 10, wherein the sensor is at least one camera directed to the user.
